(19) United States
(12) Patent Application Publication
(10) Pub. No.: US 2012/0239360 A1
(43) Pub. Date: Sep. 20, 2012

(54) BUFFER WORKSHOP

(76) Inventor: Michael Bello, Mountain View, CA (US)

(21) Appl. No.: 13/423,126

(22) Filed: Mar. 16, 2012

Related U.S. Application Data
(60) Provisional application No. 61/453,819, filed on Mar. 17, 2011.

(51) Int. Cl. G06F 17/10; G06G 7/58

(52) U.S. Cl. 703/2

(57) ABSTRACT

A method and system for automatically determining properties of the buffers solutions composed of selected ionic species by a computing system is described. The computing system provides a user interface of ionic species and receives a selection one or more of the species for a solution via the user interface. The computing system automatically calculates one or more properties of the solution and updates the user interface with the calculated one or more properties of the solution.

### RELATED APPLICATIONS

This application claims the benefit of U.S. Provisional Application No. 61/453,819, filed Mar. 17, 2011, the entire contents of which are incorporated by reference.

### TECHNICAL FIELD

Embodiments of the present invention relate to the field of processing data, and more particularly, to a buffer solution tool for selecting components of a solution and molarities of the components in order to obtain desired properties of the solution.

### BACKGROUND

Solutions of the ionic species (aqueous and non-aqueous) are used widely in biochemistry, pharmaceutical industry, and analytical chemistry as the media for separation of biochemical ionic compounds. The properties of the solutions such as pH, ionic strength, buffering capacity and, in some cases, electric conductivity are the properties that determine the quality of the separation. Sometimes the optimal composition of the solution is obtained by experimental trials, which is time and resource consuming.

In addition to being time and resource intensive, preparation of the buffer solution usually involves titration part, which adds a strong acid or base to reach desired pH of the solution. The amount of added reagent is often unknown and, therefore, the properties of the solution besides the pH, which is adjusted, remain unknown as well. Not being able to fully characterize the solutions used in separations leads to uncertainty and the need for additional experiments.

There has not been enough progress made in automating and computerizing the process of buffer solution preparation despite the fact that mathematical formulation of the laws governing the behavior of the solutions is well known. There are at least two reasons for this state of affairs: relative complexity of the equations and lack of comprehensive data covering all relevant properties of the species.

The equations governing the properties of multi-component solutions under interest may include equations of dissociation equilibrium, mass balance, and electro-neutrality. Although these equations predict pH, ionic strength, buffering capacity and electric conductivity with a reasonable degree of the accuracy (given correct input), it is hard to solve numerically without a computer and software tools.

The parameters of the ionic species used to calculate properties of multi-component solutions may include dissociation constants, activity coefficients, temperature coefficients of the dissociation constants, motilities, etc. Although some of the parameters are well studied, other parameters are not. The data may also not be readily available for all parameters of interest.

Conventional software tools provide a computational engine and a database of predefined buffers or predefined species. The databases, however, are individual and isolated databases that lack collaboration. Furthermore, the user interfaces of the conventional solutions are desktop applications that do not allow for easy adjustment and assessment of multiple properties and composition of the solution at the same time. One conventional software tool calculates composition of any buffer and acid-base mixture, and calculates pH, Ionic Strength and Buffering Capacity. This conventional software tool does not calculate mobilities and charges of the whole range of species, does not calculate electric conductivity, does not implement activity correction, does not allow multi-parameter interactive adjustment of the composition and properties of the solution, does not support data exchange between the individual databases, does not provide a reference to the properties of the species. Another conventional solution calculates a recipe for linear, convex, or concave pH curve of a solution created by a two chamber linear mixer, and is applicable to the composition of immobilines only. This software tool does have constraints on the ionic strength and buffering capacity, does not provide interactivity, does not support data exchange, and does not calculate electric conductivity.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 is a block diagram of exemplary network architecture in which embodiments of a buffer solution tool may operate.

FIG. 2 is another is a block diagram of exemplary network architecture in which embodiments of a web-based buffer solution tool may operate.

FIG. 3 is a flow diagram of one embodiment of a method of calculating and re-calculating properties of a solution of one or more selected ionic species.

FIG. 4 is a flow diagram of one embodiment of a method of submitting additional data of ionic species into a centralized database.

FIG. 5 illustrates a diagrammatic representation of a machine in the exemplary form of a computing system for automated buffer solution generation.

FIG. 6 is a screenshot of a main screen of a buffer workshop with a components pane and an ion properties pane according to one embodiment.

FIG. 7 is a screenshot of a new solution creation screen of the buffer workshop according to one embodiment.

FIG. 8 is a screenshot of a standard buffer solution created in the buffer workshop according to one embodiment.

FIG. 9 is a screenshot of a titration screen of the buffer workshop for interactive adjustment of concentrations of the solution components according to one embodiment.

FIG. 10 is another screenshot of another titration screen of the buffer workshop for interactive adjustment of concentrations of the solution components according to one embodiment.

FIG. 11 is a screenshot of a screen to add a component to the buffer solution according to one embodiment.

FIG. 12 is a screenshot of the titration screen of the buffer workshop for interactive adjustment of concentrations of the solution components with the added component according to one embodiment.

FIG. 13 is another screenshot of another titration screen of the buffer workshop for interactive adjustment of concentrations of the solution components with the added component according to one embodiment.

FIG. 14 is a screenshot of a main screen of a buffer workshop with controls for interactive adjustments of the molarities of the solution according to one embodiment.

### DETAILED DESCRIPTION

A method and system for automatically and interactively determining buffers solutions for selected ionic species by a computing system is described. The computing system provides a user interface of ionic species and receives a selection one or more of the species for a solution via the user interface. The computing system automatically calculates one or more properties of the solution and updates the user interface with the calculated one or more properties of the solution. It should be noted that the computing system automatically calculates the properties and updates the user interface to allow a user to interactively determine buffer solutions. The computing system provides visual feedback to a user by computing the properties to allow the user to interactively make adjustments to the selection of species of a solution, as well as the parameters of the species, such as concentration. The embodiments described herein may be used to reduce the time and expense of experiments to determine buffer solutions with the appropriate species and concentrations. The interactive nature of the embodiments described herein provides an effective method of selecting and adjusting concentrations of the species for the buffer solution.

In the following description, numerous details are set forth. It will be apparent, however, to one of ordinary skill in the art having the benefit of this disclosure, that embodiments of the present invention may be practiced without these specific details. In some instances, well-known structures and devices are shown in block diagram form, rather than in detail, in order to avoid obscuring the embodiments of the present invention.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving,” “generating,” “communicating,” “capturing,” “executing,” “defining,” “specifying,” “creating,” “recreating,” “processing,” “providing,” “computing,” “calculating,” “determining,” “displaying,” or the like, refer to the actions and processes of a computing system, or similar electronic computing systems, that manipulates and transforms data represented as physical (e.g., electronic) quantities within the computing system's registers and memories into other data similarly represented as physical quantities within the computing system memories or registers or other such information storage, transmission or display devices.

Embodiments of the invention relate to a computer system, including mobile, network, and desktop applications for interactive modeling and design of the ionic solutions with desired properties.

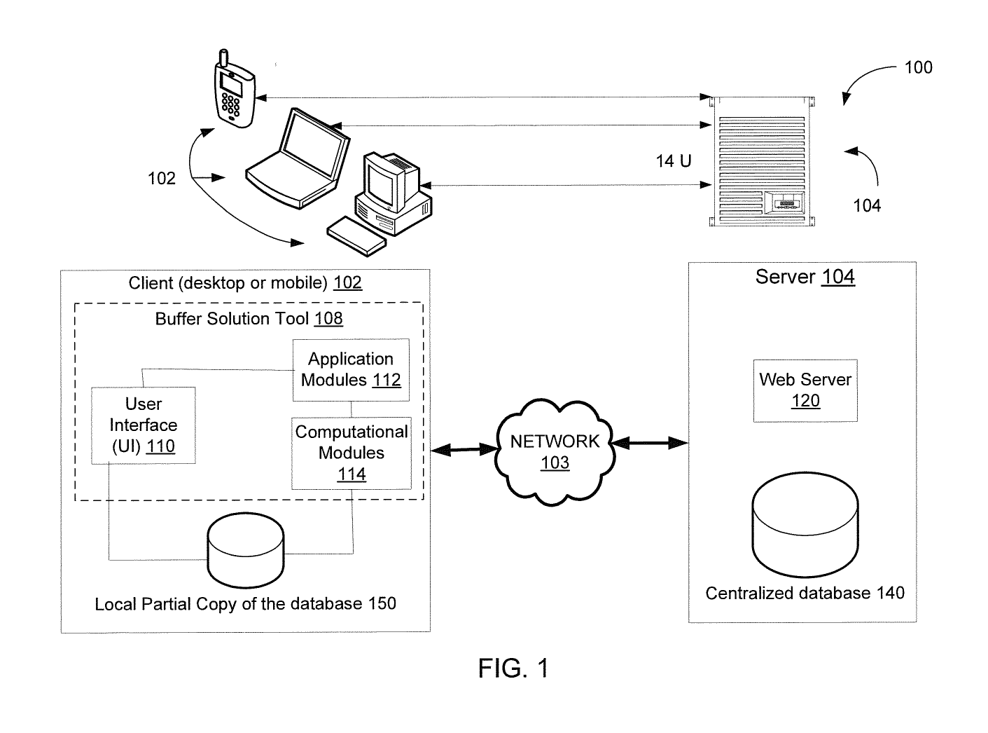

FIG. 1 is a block diagram of exemplary network architecture 100 in which embodiments of a buffer solution tool 108 may operate. The network architecture 100 may include multiple client computing systems 102 (also referred to herein as client 102), and a computing system 104 coupled via a data communications network 103 (e.g., public network such as the Internet or private network such as a local area network (LAN)). The network 103 may include the Internet and network connections to the Internet. Alternatively, the server 104 and the client 102 may be located on a Personal area network (PAN), Campus Area Network (CAN), Metropolitan area network (MAN), Wide area network (WAN), wireless local area network, cellular network, virtual local area network, or the like. The client 102 may be a client workstation, a server, a computer, a portable electronic device, a mobile phone, or other electronic devices. For example, portable electronic devices may include, but are not limited to, cellular phones, portable gaming systems, portable computing devices, or the like. The client 102 may have access to the Internet via a firewall, a router, or other packet switching devices. The server computing systems 104 may be a network appliance, a gateway, a personal computer, a desktop computer, a workstation, etc.

In one embodiment, the computing environment 100 also includes one or more content repositories, illustrated as data storage device 140 and 150. The data storage devices 140 and 150 may be a content repository in which a centralized database or a local partial or complete copy of the database may be stored. In the depicted embodiment, the server 104 includes a centralized database 140 and client 102 includes a local partial copy of the database 150. The local database 150 may also store data for the particular client or for an entity for which the client 102 belongs. For example, the client may be part of an entity that stores proprietary data associated with the created buffer solutions that the entity does not want stored as part of the centralized database 140. The centralized database 140 may be shared across different entities or may be a dedicated database for one entity.

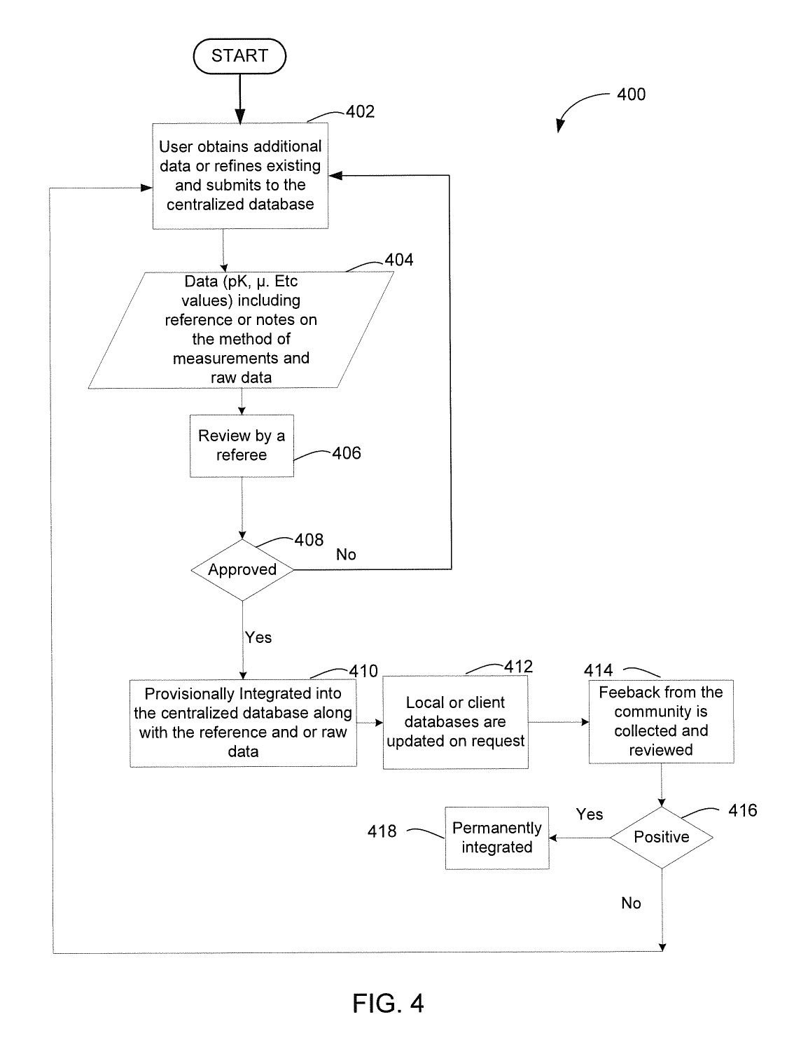

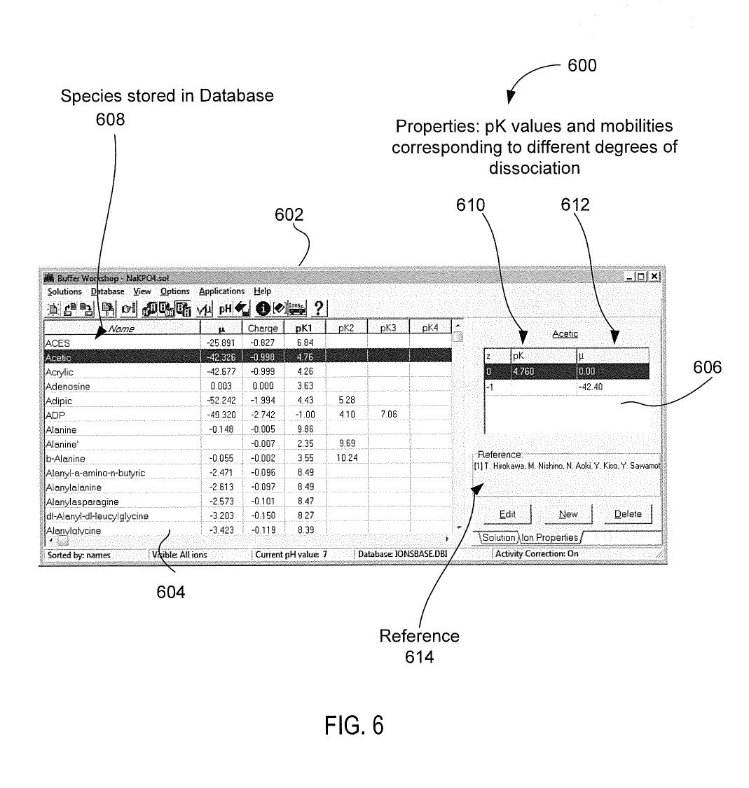

In the depicted embodiment, the buffer solution tool 108, also referred to herein as buffer workshop, includes a user interface 110, an applications module 112, and computational modules 114. The buffer solution tool 108 can access a database of ionic species in the database, which may be stored in the database 150, the centralized database 140, or a combination of both. The buffer solution tool 108 can access the centralized database 140 via a web server 120 executing on the server 104. The web server 120 receives one or more requests from the buffer solution tool 108 and responds to the requests with information stored in the database 140. The buffer solution tool 108 allows users to interactively select the components of a solution and adjust both composition of the solution and molarity of the components in order to obtain desired properties of the solution via the user interface 110. FIGS. 6-13 illustrates various screen shots of various embodiments of the user interface 110, as well as some scenarios of selected species and adjusting the selection of species of the parameters associated with the species. In other embodiments, a human network of users may contribute to the expansion of the centralized database 140 and the refining of database data as well as to the addition of new application and computational modules deployed in the buffer solution tool 108. These contributions may be made via the user interface 110, such as described below with respect to FIG. 4, or other input mechanisms as would be appreciated by one of ordinary skill in the art having the benefit of this disclosure.

The application module 112 are application software modules that implement the functionality as described herein, such as designing a new solution application, interactive chart and adjustment applications, a Titration application, or the like. Alternatively, the application modules 112 may include other applications that can utilize the database 140 in other ways as would be appreciated by one of ordinary skill in the art having the benefit of this disclosure. For example, additional or new application modules can be added to cover different methods or separation or analysis and using the same database and computation modules 114.

The computational modules 114 are configured to compute the properties of the solution based on the selection of the species and the corresponding parameters of the selected species. In one embodiment, the computational modules 114 are configured to numerically solve a set of non-linear equations. Below is a list of non-linear equations (Eq. A1-A15) that can be used in computing the properties of the solution.

Mathematical Model and Governing Equations:

$${K}_{i}^{n} = \frac{{a}_{{H}^{+}} {a}_{i}^{n - 1}}{{a}_{i}^{n}} \qquad ( Eq . A1 )$$

Eq. A1 is the equation of chemical equilibrium between the dissociated fractions of a specie i, where Kᵢⁿ is the thermodynamic equilibrium constant, a_{H}_{⁺} is the activity of the proton and aᵢⁿ is the activity of the dissociated fraction n of a specie i in the solution

a_{H}_{⁺}a_{OH}_{^{−}}=K_{w} (Eq. A2)

Eq. 2 represents the equilibrium of dissociation of water, where a_{OH}_{^{−}} is activity of the hydroxyl ion, and K_{w} is the equilibrium constant of water.

aᵢⁿ=γⁿcᵢⁿ (Eq. A3)

Eq. A3 is the relationship between activity of a fraction n of a specie i and its concentration cᵢⁿ. γⁿ is the activity coefficient

$${C}_{i} = {\sum }_{n} {c}_{i}^{n} \qquad ( Eq . A4 )$$

Eq. A4 represents the law of mass conservation for a specie i, where Cᵢ is the total concentration of the specie i.

$${\sum }_{i} {C}_{i} {Q}_{i} + {c}_{{H}^{+}} - {c}_{{OH}^{-}} = 0 \qquad ( Eq . A5 )$$

Eq. A5 is the equation of charge conservation, where average electric charge of specie in a solution is given by

$${Q}_{i} = {\sum }_{n} {z}_{i}^{n} {α}_{i}^{n} \qquad ( Eq . A6 )$$

Eq. A6 represents average charge of specie i.

$${α}_{i}^{n} = \frac{{c}_{i}^{n}}{{C}_{i}} \qquad ( Eq . A7 )$$

Eq. A7 defines degree of dissociation n of specie i.

$${μ}_{i} = {\sum }_{n} {μ}_{i}^{n} {α}_{i}^{n} \qquad ( Eq . A8 )$$

Eq. A8 is the average mobility of specie i.

pKᵢ=−log(Kᵢ) (Eq. A9)

pH=−log(a_{H}_{⁺}) (Eq. A10)

Eqs. A9 and A10 are definitions of pK and pH, respectively.

pKᵢ=pKᵢ(T) (Eq. A11)

Eq. A11 is a general representation of the pK dependence on temperature. The first implementation assumes the pK to be constants but temperature dependencies may be added.

γⁿ=γⁿ(I) (Eq. A12)

Eq. A12 is a general representation of the activity coefficient dependence on ionic strength. Davis formula is being used in the first implementation but other models can be used in the future.

$$I = \frac{1}{2} {\sum }_{i} {\sum }_{n} {( {z}_{i}^{n} )}^{2} {c}_{i}^{n} \qquad ( Eq . A13 )$$

Eq. A13 is the definition of ionic strength

$$σ = {\sum }_{i} {μ}_{i} {C}_{i} + {μ}_{{H}^{+}} {c}_{{H}^{+}} + {μ}_{{OH}^{-}} {c}_{{OH}^{-}} \qquad ( Eq . A14 )$$

Eq. A14 represents a formula for calculating electric conductivity in the limit of low concentrations. In addition to or instead of Eq. A14, more sophisticated models for electric conductivity, such as well-known Fuoss-Onsager equations, can be applied

$$β = \frac{{dc}_{B}}{dpH} \qquad ( Eq . A15 )$$

Eq. A15 is the definition of the buffering capacity, where c_{B} is the concentration of a strong base.

In other embodiments, additional equations may be used to calculate the properties of the solution as would be appreciated by one of ordinary skill in the art having the benefit of this disclosure.

In one embodiment, the local database 150 is a partial copy of the centralized database 140, and the partial copy may include the tables used for the calculations by the computational modules to calculate the properties of the solution of selected species. In one embodiment, the local database 150 is implemented using open source SQLite database, and the centralized database 150 is a client-server relational database management system (RDBMS).

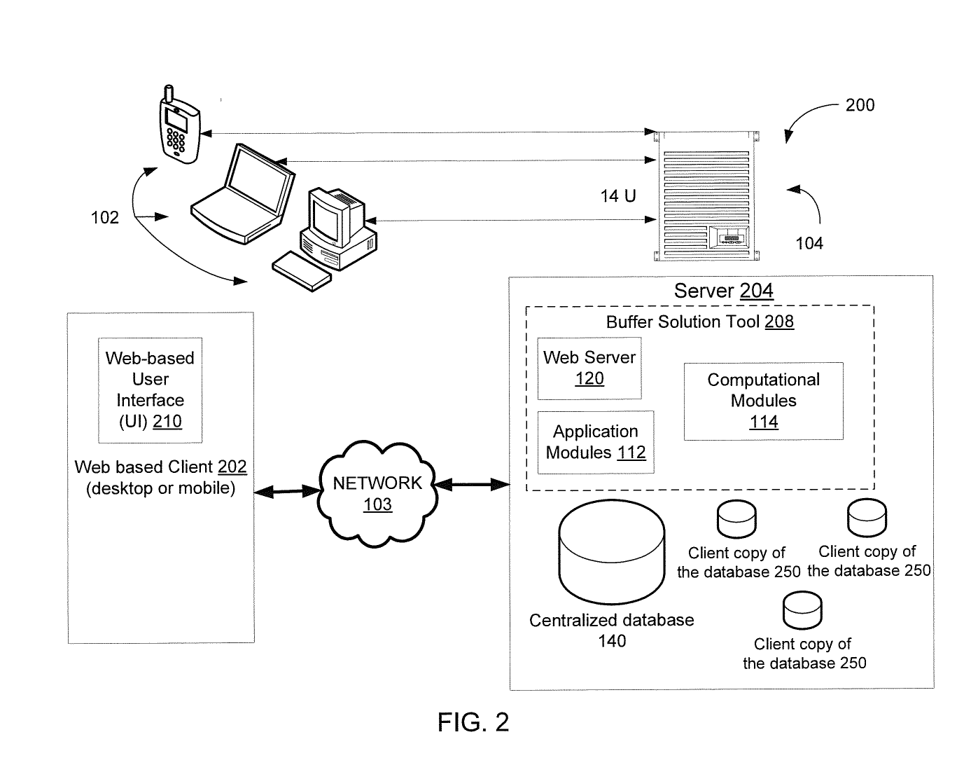

In the depicted embodiment of FIG. 1, the client 102 executing the buffer solution tool 108 may be a desktop computer. For example, as depicted in FIG. 1, the client 102 may be a mobile device, such as a laptop com. Also, as depicted in FIG. 1, the buffer solution tool 108 includes the user interface 110, application module 112, computational modules 114, a local copy of the database 150, and a centralized network copy of the database 140. In FIG. 1, the UI 110, application modules 112, computational modules 114, and the local copy of the database 150 reside on the client 102. In other embodiments, similar functionality can be implemented in a thin client or other client device that interacts with a server that hosts the application modules 112, computational modules 114, centralized database 140, and client copies of the databases (e.g., 250), such as illustrated in FIG. 2. For example, the buffer solution tool 108 may be implemented as a web-based application. Alternatively, other configurations of the buffer solution tool 108 are possible as would be appreciated by one of ordinary skill in the art having the benefit of this disclosure.

FIG. 2 is another is a block diagram of exemplary network architecture 200 in which embodiments of a web-based buffer solution tool 208 may operate. The network architecture 200 is similar to the network architecture 100 as noted by similar reference numbers. The web-based buffer solution tool 208 the applications module 112, computational modules 114, and web server 120 that can be accessed by a web-based user interface 210 on a web-based client 202. The web-based client 202 may be a client workstation, a server, a computer, a portable electronic device, a mobile phone, or other electronic devices. For example, portable electronic devices may include, but are not limited to, cellular phones, portable gaming systems, portable computing devices, or the like. The web-based client 202 may have access to the Internet via a firewall, a router, or other packet switching devices. The server computing systems 204 may be a network appliance, a gateway, a personal computer, a desktop computer, a workstation, etc.

In one embodiment, the same server computing system 104 may execute the web server 120 and the buffer solution tool 208. Alternatively, the functionality of the buffer solution tool 208 and the web server 120 can be distributed over the two machines. For example, in one embodiment, the server computing system 104 may host just the buffer solution tool 208 and not the web server 120, and another server computing system (not illustrated) can host the web server 120 to handle requests for the buffer solution tool 208. Alternatively, other configurations are possible as would be appreciated by one of ordinary skill in the art having the benefit of this disclosure.

The server computing system 205 includes the centralized database 140 and one or more client copies of the database 250. The databases 250 may be similar to the local database 140 described above with respect to FIG. 1. The buffer solution tool 208 can access a database of ionic species in the database 140, database 250, or a combination of both. Instead of accessing the centralized database 140 via the web server, the buffer solution tool 208 can access the centralized database 140 directly. The web server 120 receives one or more requests from the web-based user interface 210 and responds to the requests with information stored in the database 140 or 250. The buffer solution tool 208 allows users to interactively select the components of a solution and adjust both composition of the solution and molarity of the components in order to obtain desired properties of the solution via the web-based user interface 210. FIGS. 6-13 illustrates various screen shots of various embodiments of the web-based user interface 210, as well as some scenarios of selected species and adjusting the selection of species of the parameters associated with the species. As described above, the human network of users may contributed to the centralized database 140 and the refining of database data as well as to the addition of new application and computational modules deployed in the buffer solution tool 208. These contributions may be made via the web-based user interface 210, such as described below with respect to FIG. 4, or other input mechanisms as would be appreciated by one of ordinary skill in the art having the benefit of this disclosure.

The buffer solution tool 108, 208 may perform calculations of the solution properties using input parameters stored in the database 140 or 150, such as the pK values and mobilities of the species. The accuracy of the calculations and the ability to perform calculations depends on the accuracy and availability of the pK values, mobilities, as well as coefficients for the models describing dependencies of the activity on the ionic strength, pK on the temperature and mobilities on both the temperature and concentration. Such data may not be readily available for all known ionic species. Some of the available data are collected in the centralized database 140 together with the references to the sources. Embodiments described herein also provide a method of updating, expanding, and refining data in the centralized database 140, such as the method 400 illustrated in FIG. 4.

In one embodiment, the centralized database 140 is implemented as a relational database. The database may include several major tables, such as “ions,” “references,” and “ions_references” that enables relationship many-to-many between the ions and references. In one embodiment, both the “ions” table and “references” have a unique identifier as a primary key. The unique identifier may be a computer-generated random 6-symbol alphanumerical character string. In one embodiment, the unique identifier is not globally unique, which would need a longer string or a centralized mechanism of generation, but may be long enough to make collisions unlikely within this particular field. In another embodiment, the unique identifier is globally unique. In some embodiments, since the integration with the centralized database 140 is a process that involves manual review that can resolve the potential conflicts of global non-uniqueness at the integration phase. For example, the same time 6 symbol key makes collisions for the envisioned number of database entries (thousands) very unlikely. The database design allows for increasing the size of the key in the future without affecting existing keys.

In other embodiments, the “ions” table may have fields that contain the name of the chemical specie, pK values, mobility values, and “recommended” flag. The “recommended” flag may represent the record containing data mostly approved by the users, administrators of the system, or a combination of both. Additional fields, such as coefficients of pK temperature dependence, various coefficients for the activity models, diffusion coefficients, ions sizes can be added as needed. These additional fields can be used without redesigning the database 140 or the applications. For example, these additional fields can be added as the columns to the “ions” table or as separate tables referencing the unique identifier of the specie. Additional field relating to the solvent (currently assumed to be water) can be also added, thus extending the system to support non-aqueous ionic solutions, for example.

In other embodiments, records of the “references” table may also have a unique identifier analogous to the identifier used in the “ions” table. Records of the “references” table may include literature references to published results, keys to the user who submitted the references, the submission date, optional comment, the reviewer, in case of the originally obtained data. Additional tables containing original data, comments on the original data, etc. may all have references to the unique identifier to the “references” record. In one embodiment, the additional tables mentioned above are stored in the centralized database 140 and are not copied to the user devices as a part of the local database 150 (or client databases 250, and may be accessible via the web server 120.

In other embodiments, the “ions_references” table may have records containing the “ions” ID and “references” ID thus linking them together. This is an implementation of many-to-many relationship allowing for multiple species be referenced by one source (a book, for instance) and may have multiple sources providing data for the same specie.

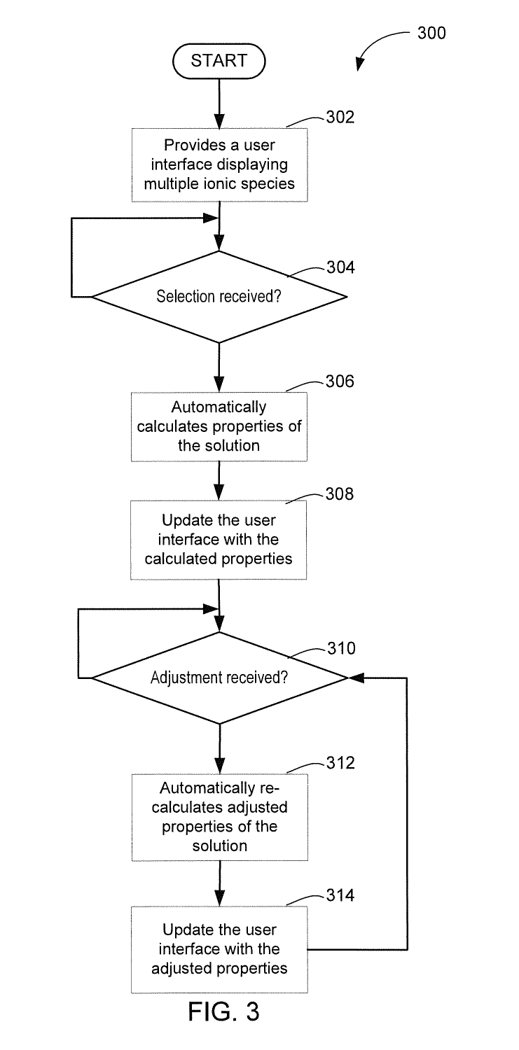

FIG. 3 is a flow diagram of one embodiment of a method 300 of calculating and re-calculating properties of a solution of one or more selected ionic species. The method 300 is performed by processing logic that may comprise hardware (circuitry, dedicated logic, etc.), software (such as is run on a general purpose computing system or a dedicated machine), firmware (embedded software), or any combination thereof. In one embodiment, the buffer solution tool 108 of FIGS. 1 or the buffer solution tool 208 of FIG. 2 performs the method 300. Alternatively, other components of the client computing system 102 and the server computing systems 104 can perform some or all of the operations of method 300.

Referring to FIG. 3, processing logic begins with providing a user interface displaying multiple ionic species (block 302). The processing logic determines if a selection of one or more of the ionic species is received for a solution (block 304). The processing logic may also receive a first set of parameters corresponding to the selection of ionic species via the user interface. If not, the processing logic waits until a selection is received at block 304. When the selection is received, the processing logic automatically calculates one or more properties of the solution (block 306), and updates the user interface with the calculated properties of the solution (block 308). The processing logic determines if a first adjustment to the first set of parameters, a second adjustment of the selection, or both at the same time is received (block 310). The processing logic can wait until the first adjustment, second adjustment, or both are received. When adjustments are received, the processing logic automatically re-calculate one or more adjusted properties of the solution using the first adjustment, the second adjustment, or both (block 312), and updates the user interface with the adjusted properties of the solution (block 314), and the method may return to block 310.

In yet a further embodiment, the processing logic at block 306 computes a pH level, an ionic strength, a buffering capacity, and an electric conductivity as the one or more properties of the solution, and the processing logic at block 312 computes an adjusted pH level, an adjusted ionic strength, an adjusted buffering capacity, and an adjusted electric conductivity as the one or more adjusted properties of the solution.

In another embodiment, the processing logic at block 304 receives a first input of a first molarity as part of the first set of parameters for at least one of the selected ionic species, and the processing logic at block 306 computing the one or more properties of the solution using the first molarity for the at least one selected ionic specie. In a further embodiment, the processing logic at block 310 receives a second input of a second molarity for the at least one selected ionic specie, and the processing logic at block 312 re-calculates the one or more adjusted properties using the second molarity. In one embodiment, the processing logic at block 306 computes a pH level of the solution using the first molarity for the at least one selected ionic species, and at block 312 computes an adjusted pH level of the solution using a second molarity.

In some embodiments, the processing logic solves numerically a set of non-linear equations at blocks 306 and 312. The non-linear equations may be those described above.

In another embodiment, the processing logic at block 310 receives input of an additional component selected for the solution, and re-calculates at block 312 the one or more adjusted properties of the solution.

In another embodiment, the processing logic provides the user interface by displaying a list of ionic species stored in a database. The database may be a centralized database, a local database, or a combination of both. In some embodiment, entries of the database store a set of default ion properties, such as a pK value and a mobility value for the respective one of the ionic species.

In another embodiment, the processing logic computes a pH level as a function of molarity for a first one of the selected components of the solution at block 306, and the processing logic updates the user interface by providing a first graph showing the pH level as the function of the molarity at block 308. In a further embodiment, the processing logic computes an adjusted pH level as a function of molarity for the first one of the selected components of the solution at block 312, and the processing logic updates the user interface with the adjusted properties by updating the first graph showing the adjusted pH level as the function of the molarity at block 314.

In another embodiment, the processing logic at block 306 computes a specified property of the first selected component as a function of the molarity, such as ionic strength of the first selected component or buffering capacity of the first selected component. The processing logic may update the user interface by providing a second graph showing the specified property as the function of the molarity. The second graph can be display separately or overlaid with the first graph as illustrated in some of the screen shots described below. In a further embodiment, the processing logic at block 312 computes an adjusted property of the first selected component as a function of the molarity, and updates the user interface by updating the second graph showing the adjusted property as the function of the molarity at block 314.

Embodiments described herein also provide a method of updating, expanding, and refining data in the centralized database 140, such as the method 400 illustrated in FIG. 4.

FIG. 4 is a flow diagram of one embodiment of a method 400 of submitting additional data of ionic species into a centralized database. The method 400 may begin with a user finding additional or more precise data elsewhere or refines existing data and submits the additional data to the database (block 402). The user may submit the additional data to the local database 150 (or 250) or to the centralized database 140. The user may submit the data via the user interface 110 or web-based user interface 210 or by other mechanisms as would be appreciated by one of ordinary skill in the art having the benefit of this disclosure, such as via a material submission system, email, or the like. The administrator of the centralized database may receive the additional data (block 404), such as pK values, mobilities, or other parameters or properties of one or more solutions, and the data may be reviewed by a referee, such as the administrator of the database, a group of peers, or other entities to verify or validate the submitted data (block 406). The data may be submitted with all attributes of the submitter and the date of submission and may include raw data and description of the measurement procedure in case the data are original. The referee and administrator may be the same person or different people. If the additional data is approved at block 408, the administrator may provisionally integrate the additional data into the centralized database along with the reference, the raw data, or both (block 410). Provisionally approved data can be copied to the local or client databases on request (block 412). Alternatively, the updates can be pushed out to the local or client databases without specific requests. The administrator can collect and review feedback from the community on the additional data (block 414). If the administrator determines that the feedback is positive at block 416, the additional data can be permanently integrated into the centralized database (block 418) and the additional data can be included in the updates of the local or client databases. If at block 408 the referee does not approve the submission, the additional data is not integrated into the centralized database, and the method returns to block 402. If at block 416 the administrator determines that the feedback is not positive, the administrator may remove the additional data from the centralized data and return to block 402.

In other embodiments, some of the operations described above may be performed by processing logic that may comprise hardware (circuitry, dedicated logic, etc.), software (such as is run on a general purpose computing system or a dedicated machine), firmware (embedded software), or any combination thereof. In one embodiment, the buffer solution tool 108 of FIGS. 1 or the buffer solution tool 208 of FIG. 2 performs some or all of the method 400. Alternatively, other components of the client computing system 102 and the server computing systems 104 can perform some or all of the operations of method 400.

In one embodiment, the processing logic receives additional information regarding the set of ion properties of one of the plurality of ionic species. When approved by a reviewer, such as a referee or an administrator, the processing logic integrates the additional information into the respective entry the one ionic specie.

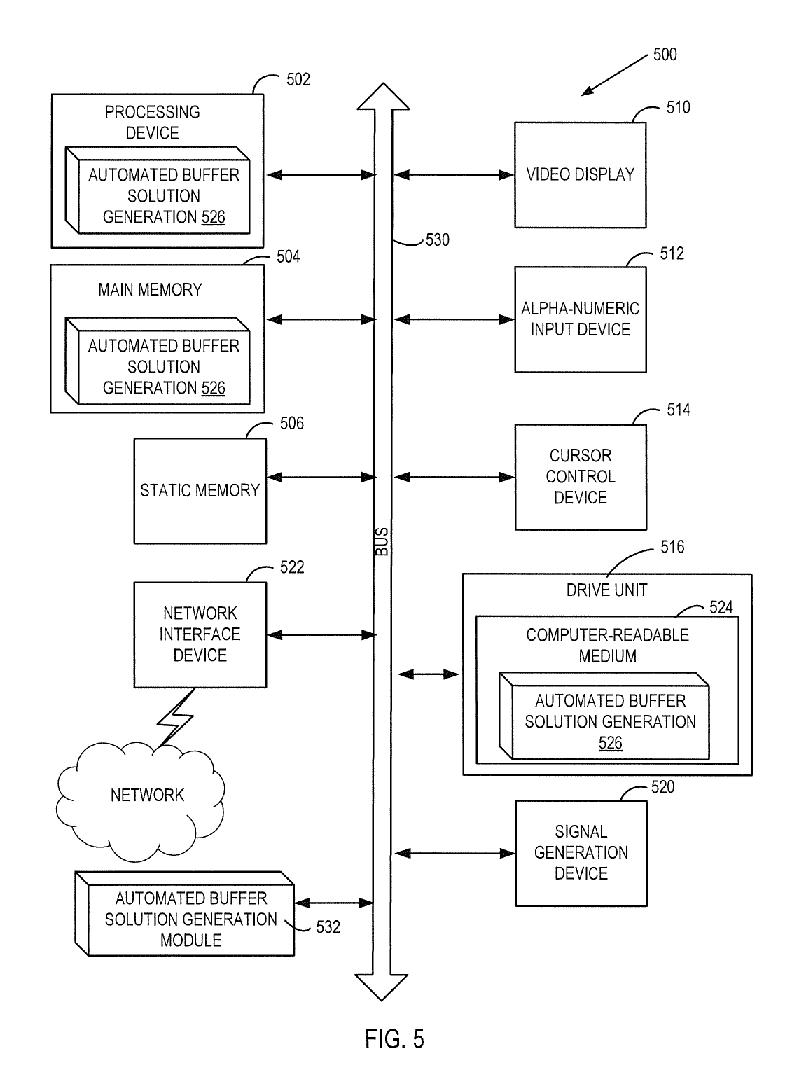

FIG. 5 illustrates a diagrammatic representation of a machine in the exemplary form of a computing system 500 for automated buffer solution generation. Within the computing system 500 is a set of instructions for causing the machine to perform any one or more of the methodologies discussed herein. In alternative embodiments, the machine may be connected (e.g., networked) to other machines in a LAN, an intranet, an extranet, or the Internet. The machine may operate in the capacity of a server or a client machine in a client-server network environment, or as a peer machine in a peer-to-peer (or distributed) network environment. The machine may be a PC, a tablet PC, a set-top-box (STB), a personal data assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein for automated buffer solution generation, such as the method 300 described above. In one embodiment, the computing system 500 represents various components that may be implemented in the one or more server computing systems 104 as described above. Alternatively, the server computing system 104 may include more or less components as illustrated in the computing system 500.

The exemplary computing system 500 includes a processing device 502, a main memory 504 (e.g., read-only memory (ROM), flash memory, dynamic random access memory (DRAM) such as synchronous DRAM (SDRAM), etc.), a static memory 506 (e.g., flash memory, static random access memory (SRAM), etc.), and a data storage device 516, each of which communicate with each other via a bus 530.

Processing device 502 represents one or more general-purpose processing devices such as a microprocessor, central processing unit, or the like. More particularly, the processing device 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 may also be one or more special-purpose processing devices such as an application specific integrated circuit (ASIC), a field programmable gate array (FPGA), a digital signal processor (DSP), network processor, or the like. The processing device 502 is configured to execute the processing logic (e.g., automated buffer solution generation 526) for performing the operations and steps discussed herein.

The computing system 500 may further include a network interface device 522. The computing system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 520 (e.g., a speaker).

The data storage device 516 may include a computer-readable storage medium 524 on which is stored one or more sets of instructions (e.g., automated buffer solution generation 526) embodying any one or more of the methodologies or functions described herein. The automated buffer solution generation 526 may also reside, completely or at least partially, within the main memory 504 and/or within the processing device 502 during execution thereof by the computing system 500, the main memory 504, and the processing device 502 constituting computer-readable storage media. The automated buffer solution generation 526 may further be transmitted or received over a network via the network interface device 522.

While the computer-readable storage medium 524 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing a set of instructions for execution by the machine and that causes the machine to perform any one or more of the methodologies of the present embodiments. The term “computer-readable storage medium” shall accordingly be taken to include, but not be limited to, solid-state memories, optical media, magnetic media, or other types of mediums for storing the instructions. The term “computer-readable transmission medium” shall be taken to include any medium that is capable of transmitting a set of instructions for execution by the machine to cause the machine to perform any one or more of the methodologies of the present embodiments.

The advertisement module 532, components, and other features described herein (for example in relation to FIG. 3) can be implemented as discrete hardware components or integrated in the functionality of hardware components such as ASICS, FPGAs, DSPs, or similar devices. The advertisement module 532 may implement operations of automated buffer solution generation as described herein with respect to FIG. 3. In addition, the advertisement module 532 can be implemented as firmware or functional circuitry within hardware devices. Further, the advertisement module 532 can be implemented in any combination hardware devices and software components.

As described herein, the buffer solution tool may include a desktop, mobile, or web-based user interface that allows users to create solutions of the ionic species by selecting these species from the database, and assigning them to the solution. The properties of the solution are calculated automatically by solving numerically a set of non-linear equations presented herein as the components added to the solution or as their molarities change. FIGS. 6-13 describe various screenshots of the user interface of the buffer solution tool, also referred to below as a buffer workshop.

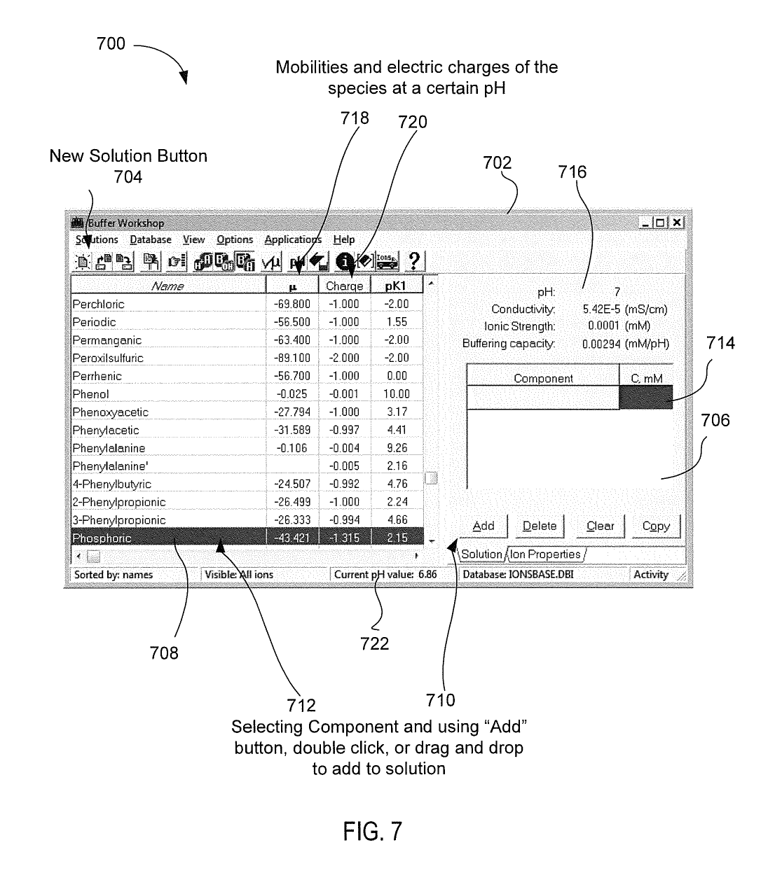

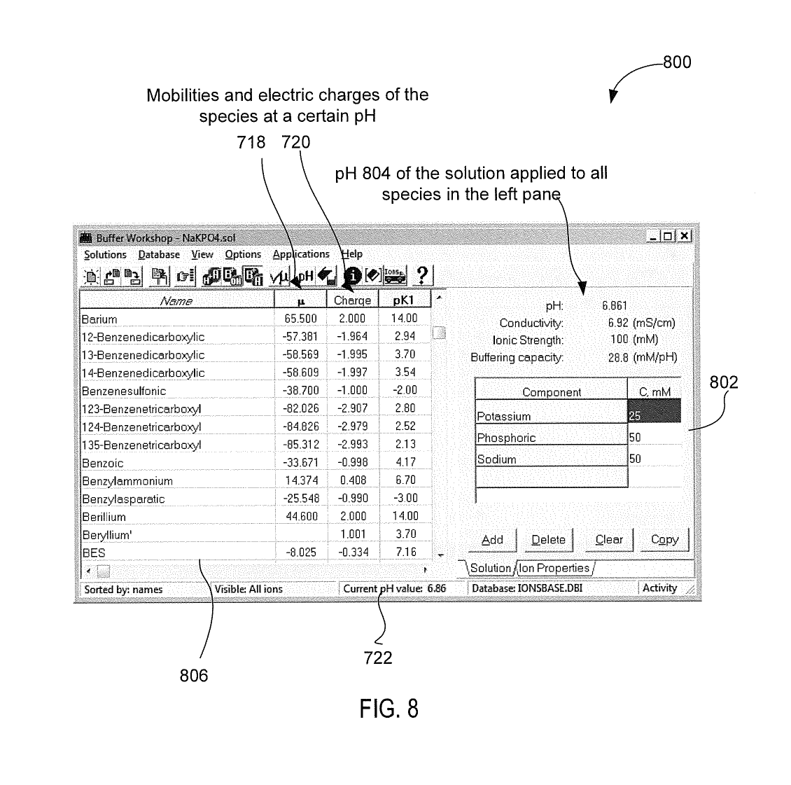

FIG. 6 is a screenshot 600 of a main screen 602 of a buffer workshop with a components pane 604 and an ion properties pane 606 according to one embodiment. The main screen 602 may be the main screen of the desktop UI. The left pane 604 shows a list of ionic species 608 stored in a database. By selecting, for instance, acetic acid, a user can assess or modify its properties (set of pKs 610 and mobilities 612) in the Ion Properties tab of the right pane 604. The main screen may also illustrate a reference 614 corresponding to the properties 610 and 612 for the selected ionic specie 608. One embodiment for facilitating the creation of a new solution is illustrated in FIGS. 7 and 8.

FIG. 7 is a screenshot 700 of a new solution creation screen 702 of the buffer workshop according to one embodiment. In the new solution creation screen 702, a user clicks a “New” button 704 or uses a menu item from “Solutions” to create a “pure water” solution on the right pane 706 of FIG. 7. As a next step, in one embodiment, the user selects an ionic specie from the list in the left pane 708 (Phosphoric, in this case) and adds it to the solution by using Add button 710, double clicking the selected species 712, or dragging and dropping the selected species into the right pane 706. Then, in one embodiment, the user is allowed to adjust the concentration to the desired value at field 714. In a similar fashion, a user can they add Potassium and Sodium to create a standard buffer solution, as illustrated in FIG. 8. The buffer workshop automatically calculates the pH, conductivity, ionic strength, and buffer capacity of the solution and presents the calculated values at the user interface at 716. The left pane 708 also illustrates the mobilities 718 and electric charges 7120 of the species in the list at a certain pH (current pH value 722).

FIG. 8 is a screenshot 800 of a standard buffer solution 802 created in the buffer workshop according to one embodiment. The standard buffer solution 802 is composed of 25 mM of Potassium, 50 mM of Sodium and 50 mM of Phosphoric Acid (25 mM KH₂PO₄+25 mM Na₂HPO₄. The standard buffer solution 802 also indicates a pH 804 of the solution applied to all species in the left pane 806. The left pane 806 also illustrates the mobilities 718 and electric charges 7120 of the species in the list at a certain pH (current pH value 722). From this screen, the user may also click on the ion properties tab to return to the other screen where additional species can be added or adjusted. The molarities of the species may also be adjusted in this screen. The buffer solution tool re-calculates the pH, conductivity, ionic strength, and buffering capacity when there is an adjustment to select one or more additional components or when adjustments are made to the properties or parameters of the selected components of the solution. The user may return to this screen from the ion properties by clicking on the solution tab.

In one embodiment, as concentration of any of the solution components changes, the buffer solution tool re-calculates the pH, Ionic Strength, Buffering Capacity and electric conductivity (in case of known mobilities). The calculation of these values may involve numerical solution of the set of equations (e.g., equations listed above). The standard buffer solution, 25 mM KH₂PO₄+25 mM Na₂HPO₄, according to the source (J. N. Butler, Ionic Equilibrium, 1998, John Wiley, p. 58) has the pH value of 6.865. The difference of 0.06% is negligible. The standard buffer solution created in FIG. 8 is an example, but any composition of the ionic species can be added and results obtained in a similar way.

In one embodiment, an additional useful feature provided is the ability to calculate mobilities and average electric charge of all ionic species in the list. Knowledge of the mobilities is important in order to assess a possibility of their separation by electrokinetic methods. Knowledge of the electric charge allows an assessment of ionic interactions. FIG. 8 shows an example of how pH of the solution displayed on the right pane is applied to the list of the ionic species by clicking a button on the toolbar. One can see that, for instance, Benzenedicarboxylic acids can be separated from Benzenetricarboxylic acids at this pH but separation of the isomers of those may need to be changed in the buffer solution.

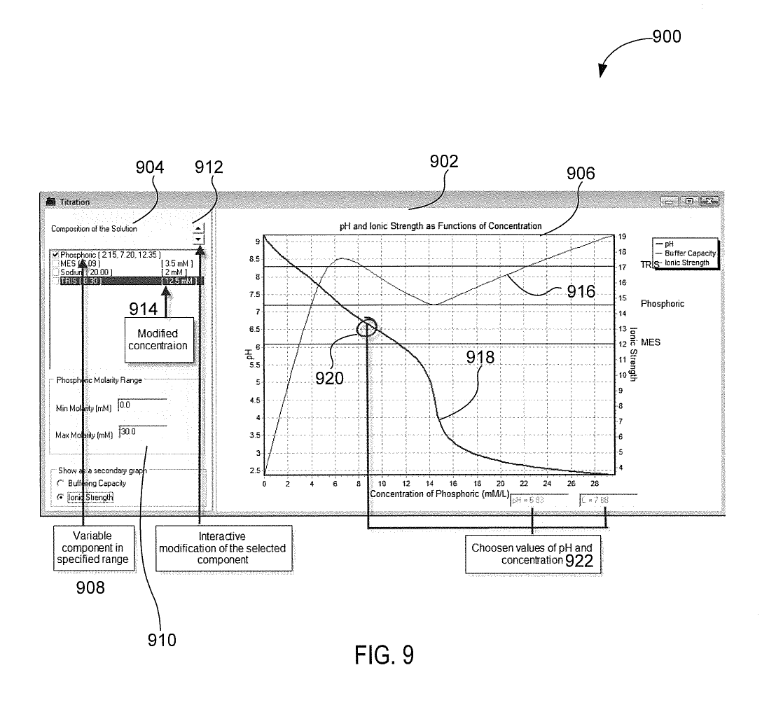

In order to create buffer solutions working in a relatively wide range of pH one needs to assess the solution behavior not just in one point but also within the whole desired range. The assessment of the solution behavior and interactive adjustment of its composition may be facilitated using a Titration application of the buffer workshop as illustrated in FIGS. 9-13.

FIG. 9 is a screenshot 900 of a titration screen 902 of the buffer workshop for interactive adjustment of concentrations of the solution components according to one embodiment. FIG. 9 shows an exemplary Solution control panel 904 (in the left pane 910) and a corresponding chart 906 displaying the dependence of pH on the concentration of the solution component chosen as a variable 908, in this case, phosphoric acid. The user can assign any of the solution components to be a variable (check box in the list) and generate a chart 906 showing properties of the solution (in this case pH and ionic strength) as a function of the molarity of the variable component. The calculation involves numerical solution of the set of equations presented herein. The range in which the variable component changes may be set by Min and Max molarity input controls on the left pane 910.

The user can select any other component in the list (TRIS in FIG. 9) and vary its molarity by using up or down arrows 912 (modified concentration 914), which leads to immediate re-calculation of the whole chart 906, thus giving user a visual feedback on the changes they make to the molarity of the component.

FIG. 9 also shows an example of Ionic Strength 916 displayed along with the pH curve 918 on the chart 906. This is another parameter that might affect the solution applicability to certain types of separation. By selecting and double clicking a point 920 on curve 918 that satisfies best all the requirements for the solution, the user may command the buffer solution tool to apply these values to the solution recipe. The selection of the point 920 also shows the chosen values of pH and concentrations at 922.

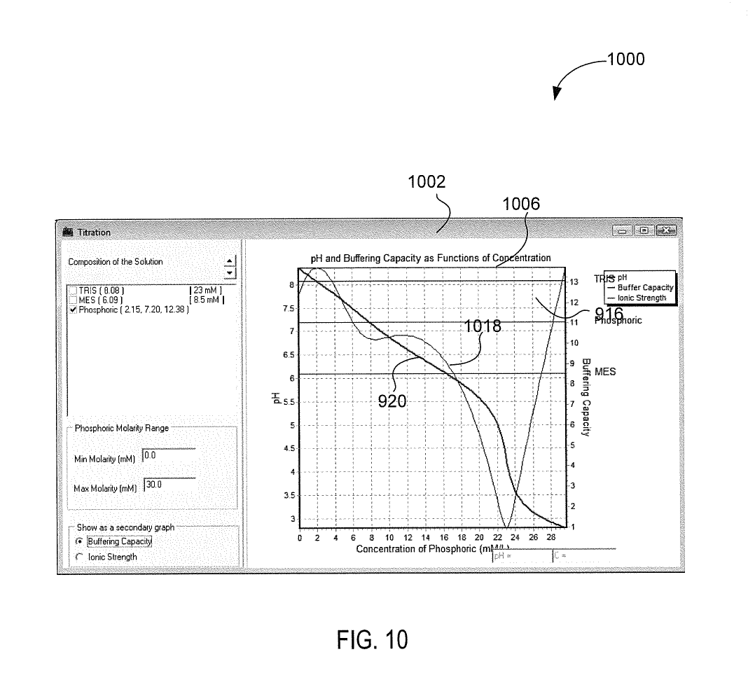

Another example of interactive design of the buffers solution is described and illustrated with respect to FIG. 10.

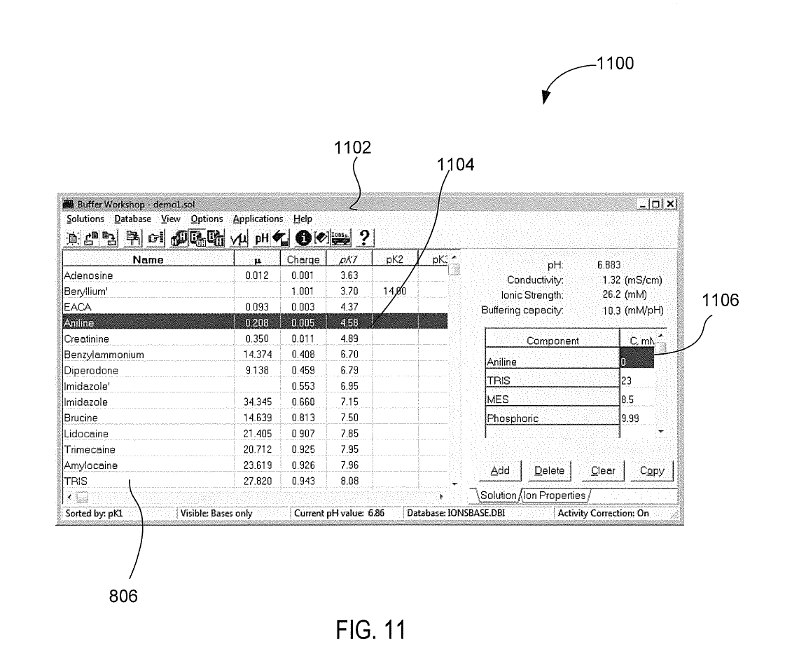

FIG. 10 is another screenshot 1000 of another titration screen 1002 of the buffer workshop for interactive adjustment of concentrations of the solution components according to one embodiment. FIG. 10 shows a chart 1006 displaying concentration dependence of pH 920 and displays the buffering capacity 1018 as a function of the concentration of the Phosphoric acid. The buffer solution is composed of TRIS, MES, and Phosphoric Acid and displays linear behavior in the range of pH from 5.7 to 8.2. In the pH range below 5.5 the pH and buffering capacity drop precipitously. In order to improve this behavior, another component may be added with pK close to the pH at which buffering capacity drops, as illustrated in FIG. 11.

FIG. 11 is a screenshot 1100 of a solution screen 1102 to add a component to the buffer solution according to one embodiment. In this embodiment, the user may choose to add an ionic component 1104 from the master list 806 of components with a pK close to pK=4.5. The ionic species list can be sorted by name, mobility, and pK. When sorted by pK, the choice of the component becomes trivial. The user may select Alanine from the list as the component having pK=4.58 and add it to the solution as described above. The buffer solution with Alanine added at concentration C=0 is illustrated in FIG. 11. By increasing concentration of Alanine using Up Down control, as described above, the user interactively adjusts the curve to linearity and buffering capacity to a higher value. The concentration can also be typed into the field 1106.

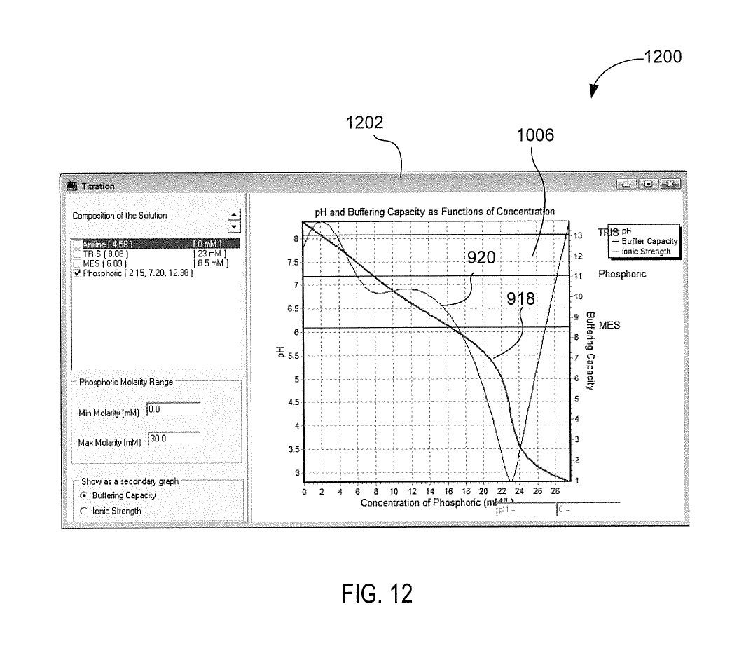

FIG. 12 is a screenshot 1200 of the titration screen 1202 of the buffer workshop for interactive adjustment of concentrations of the solution components with the added component 1104 according to one embodiment. The titration screen 1202 includes the chart 1006 (of FIG. 10) with the pH 918 and the buffering capacity 920 for the solution with the added component 1104.

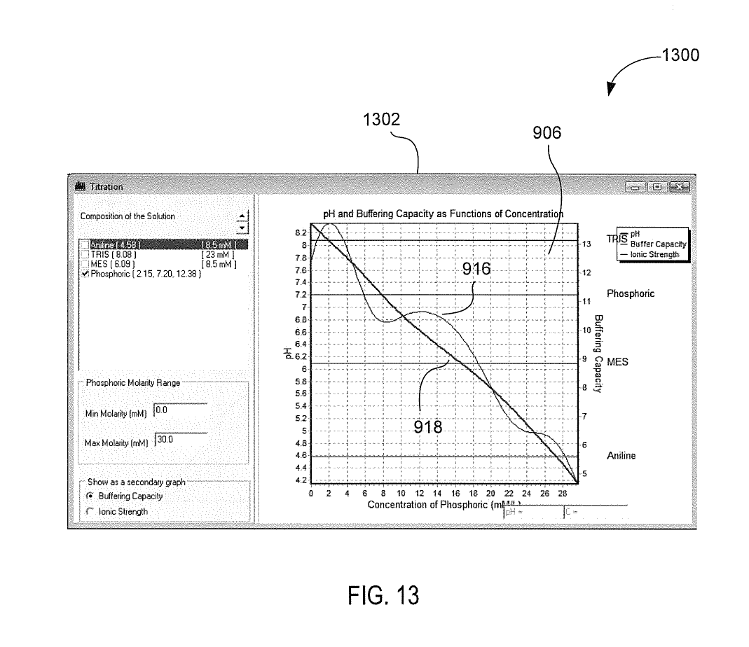

FIG. 13 is another screenshot of another titration screen of the buffer workshop for interactive adjustment of concentrations of the solution components with the added component according to one embodiment. The titration screen 1302 includes the chart 906 (of FIG. 9) with the ionic strength 916 and the pH 918 for the solution with the added component 1104.

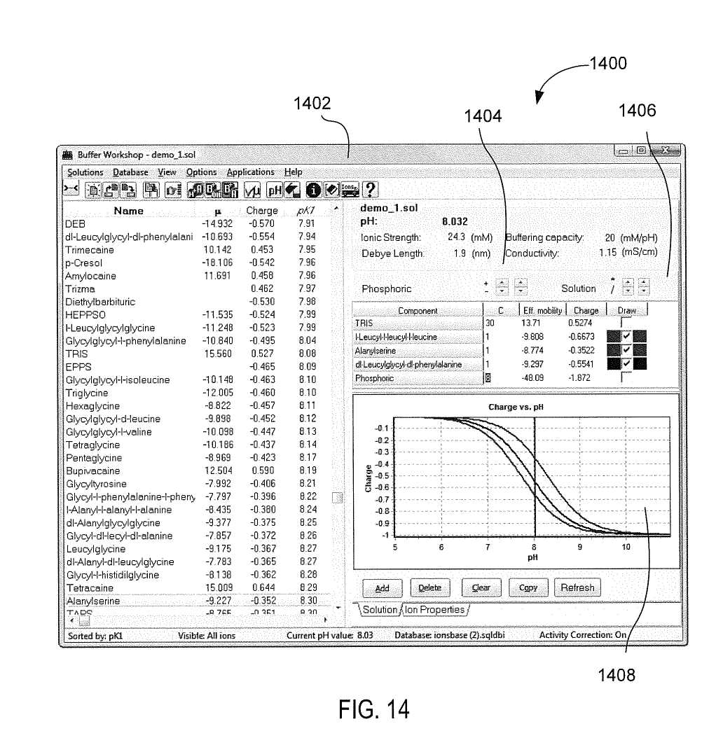

FIG. 14 is a screenshot 1400 of a main screen 1402 of a buffer workshop with controls for interactive adjustments of the molarities of the solution according to one embodiment. The main screen 1402 includes a left pane with a list of species stored in the database, and a right pane with a solution of selected species. The main screen 1402 also includes controls for interactive adjustments of the molarities of the solution. The controls 1404 can be used to interactively adjust the molarity of one of the selected species. The controls 1406 can be used to interactively adjust the molarities of the solution, such as by adjusting the molarities of all the species of the solution. The controls 1404 and 1405 are arrow controls, but other types of controls may be used as would be appreciated by one of ordinary skill in the art having the benefit of this disclosure. As above, by selecting one of the species, a user can assess or modify its properties (set of pKs and mobilities). The main screen 1402 may also include a graph 1408 that displays electric charge vs. pH for the selected species of the solution. The checkboxes can be used to add or remove the respective species of the solution from the graph 1408.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to utilize the invention and various embodiments with various modifications as may be suited to the particular use contemplated.

What is claimed is:

1. A method, implemented by a computing system programmed to perform the following, comprising:
providing a user interface comprising a plurality of ionic species;
receiving a selection of one or more of the plurality of ionic species for a solution and a first set of parameters corresponding to the selection of ionic species via the user interface;
automatically calculating one or more properties of the solution;
updating the user interface with the calculated properties of the solution;
receiving a first adjustment to the first set of parameters, a second adjustment of the selection, or both at the same time;
automatically re-calculating one or more adjusted properties of the solution using the first adjustment, the second adjustment, or both; and
updating the user interface with the adjusted properties of the solution.

2. The method of claim 1, wherein said automatically calculating the one or more properties comprises computing a pH level, an ionic strength, a buffering capacity, and an electric conductivity as the one or more properties of the solution, and wherein said automatically re-calculating the one or more adjusted properties comprises computing an adjusted pH level, an adjusted ionic strength, an adjusted buffering capacity, and an adjusted electric conductivity as the one or more adjusted properties of the solution.

3. The method of claim 1, further comprising receiving a first input of a first molarity as part of the first set of parameters for at least one of the selected ionic species, and wherein said automatically calculating the one or more properties of the solution comprises computing the one or more properties of the solution using the first molarity for the at least one selected ionic specie.

4. The method of claim 3, wherein receiving the first adjustment comprises receiving a second input of a second molarity for the at least one selected ionic specie, and wherein said automatically re-calculating comprises re-calculating the one or more adjusted properties using the second molarity.

5. The method of claim 3, wherein said automatically calculating the one or more properties comprises computing a pH level of the solution using the first molarity for the at least one selected ionic species, and wherein said automatically re-calculating the one or more adjusted properties comprises computing an adjusted pH level of the solution using a second molarity.

6. The method of claim 1, wherein said automatically calculating comprises solving numerically, by the computing system, a set of non-linear equations, and wherein said automatically re-calculating comprises re-solving numerically the set of non-linear equations.

7. The method of claim 1, wherein said receiving the second adjustment comprises receiving input of an additional component selected for the solution, and wherein said automatically re-calculating comprises re-calculating the one or more adjusted properties of the solution.

8. The method of claim 7, wherein said automatically calculating comprises solving numerically, by the computing system, a set of non-linear equations, and wherein said automatically re-calculating comprises re-solving numerically the set of non-linear equations.

9. The method of claim 1, wherein said providing the user interface comprising displaying a list of the plurality of ionic species stored in a database.

10. The method of claim 9, wherein entries of the plurality of ionic species stored in the database store a set of default ion properties comprising at least a pK value and a mobility value for the respective one of the plurality of ionic species.

11. The method of claim 10, further comprising:
receiving additional information regarding the set of ion properties of one of the plurality of ionic species; and
integrating the additional information into the respective entry the one ionic specie when approved by a reviewer.

12. The method of claim 1, wherein said automatically calculating comprises computing a pH level as a function of molarity for a first one of the selected components of the solution, wherein said updating the user interface with the calculating properties comprises providing a first graph showing the pH level as the function of the molarity, wherein said automatically re-calculating comprises computing an adjusted pH level as a function of molarity for the first one of the selected components of the solution, wherein said updating the user interface with the adjusted properties comprises updating the first graph showing the adjusted pH level as the function of the molarity.

13. The method of claim 12, wherein said automatically calculating further comprising computing a specified property of the first selected component as a function of the molarity, wherein said updating the user interface with the calculated properties comprises providing a second graph showing the specified property as the function of the molarity, wherein said automatically re-calculating further comprising computing an adjusted property of the first selected component as a function of the molarity, wherein said updating the user interface with the adjusted properties comprises updating the second graph showing the adjusted property as the function of the molarity.

14. The method of claim 13, wherein the specified property is ionic strength of the first selected component or buffering capacity of the first selected component.

15. A non-transitory computer readable storage medium including instructions that, when executed by a computing system, cause the computing system to perform a method comprising:
providing a user interface comprising a plurality of ionic species;
receiving a selection of one or more of the plurality of ionic species for a solution and a first set of parameters corresponding to the selection of ionic species via the user interface;
automatically calculating one or more properties of the solution;
updating the user interface with the calculated properties of the solution;
receiving a first adjustment to the first set of parameters, a second adjustment of the selection, or both at the same time;
automatically re-calculating one or more adjusted properties of the solution using the first adjustment, the second adjustment, or both; and
updating the user interface with the adjusted properties of the solution.

16. The non-transitory computer readable storage medium of claim 15, wherein said automatically calculating comprises computing at least one of a pH level, an ionic strength, a buffering capacity, and an electric conductivity as the one or more properties of the solution, and wherein said automatically re-calculating the one or more adjusted properties comprises computing an adjusted pH level, an adjusted ionic strength, an adjusted buffering capacity, and an adjusted electric conductivity as the one or more adjusted properties of the solution.

17. The non-transitory computer readable storage medium of claim 16, wherein receiving the first adjustment comprises receiving a second input of a second molarity for the at least one selected ionic specie, and wherein said automatically re-calculating comprises re-calculating the one or more adjusted properties using the second molarity.

18. The non-transitory computer readable storage medium of claim 15, wherein said receiving the second adjustment comprises receiving input of an additional component selected for the solution, and wherein said automatically re-calculating comprises re-calculating the one or more adjusted properties of the solution.

19. The non-transitory computer readable storage medium of claim 15, wherein said automatically calculating comprises computing a pH level as a function of molarity for a first one of the selected components of the solution, wherein said updating the user interface with the calculating properties comprises providing a first graph showing the pH level as the function of the molarity, wherein said automatically re-calculating comprises computing an adjusted pH level as a function of molarity for the first one of the selected components of the solution, wherein said updating the user interface with the adjusted properties comprises updating the first graph showing the adjusted pH level as the function of the molarity.

20. The non-transitory computer readable storage medium of claim 19, wherein said automatically calculating further comprising computing a specified property of the first selected component as a function of the molarity, wherein said updating the user interface with the calculated properties comprises providing a second graph showing the specified property as the function of the molarity, wherein said automatically re-calculating further comprising computing an adjusted property of the first selected component as a function of the molarity, wherein said updating the user interface with the adjusted properties comprises updating the second graph showing the adjusted property as the function of the molarity

21. The non-transitory computer readable storage medium of claim 20, wherein the specified property is ionic strength of the first selected component or buffering capacity of the first selected component.

22. A computing system, comprising:
a data storage device configured to store a database of a plurality of ionic species and instructions of a buffer solution tool; and
a processing device, coupled to the data storage device, to execute the instructions of the buffer solution tool to:
provide a user interface comprising a plurality of ionic species;
receive a selection of one or more of the plurality of ionic species for a solution and a first set of parameters corresponding to the selection of ionic species via the user interface;
automatically calculate one or more properties of the solution;
update the user interface with the calculated properties of the solution;
receive a first adjustment to the first set of parameters, a second adjustment of the selection, or both at the same time;
automatically re-calculate one or more adjusted properties of the solution using the first adjustment, the second adjustment, or both; and
update the user interface with the adjusted properties of the solution.

23. The computing system of claim 22, wherein the buffer solution tool is configured to compute a pH level, an ionic strength, a buffering capacity, and an electric conductivity as the one or more properties of the solution.

24. The computing system of claim 22, wherein the buffer solution tool is configured to:
receive input of an additional component selected for the solution; and
re-calculating the one or more adjusted properties of the solution.

25. The computing system of claim 22, wherein the buffer solution tool is configured to compute a pH level as a function of molarity for a first one of the selected components of the solution, to provide a first graph in the user interface, the first graph to show the pH level as the function of the molarity, to compute an adjusted pH level as a function of molarity for the first one of the selected components of the solution, and update the first graph showing the adjusted pH level as the function of the molarity.
